(19) United States
(12) Patent Application Publication
(10) Pub. No.: US 2008/0101889 A1
(43) Pub. Date: May 1, 2008

(54) FASTENER ASSEMBLY

(76) Inventor: Teng-Kuei Chen, Taipei (TW)

Correspondence Address: PAI PATENT & TRADEMARK LAW FIRM, 1001 FOURTH AVENUE, SUITE 3200, SEATTLE, WA, 98154, US

(21) Appl. No.: 11/552,526

(22) Filed: Oct. 25, 2006

(51) Int. Cl. F16B 39/24

(52) U.S. Cl. 411/156

(57) ABSTRACT

A fastener assembly has a through hole, a first element and a second element. The through hole is defined through the fastener assembly. Each of the first element and the second element has a lower part and an upper part. The upper part is mounted on the lower part. The lower part of the second element is mounted detachably on the upper part of the first element. The upper part of the second element is mounted detachably and pivotally to the lower part of the first element. The fastener assembly is mounted around an article via pivoting the first element relative to the second element without extending one end of the article through the through hole.

### BACKGROUND OF THE INVENTION

1. Field of the Invention

The present invention relates to a decoration, and especially to a decoration to be mounted around an article for ornament.

2. Description of the Related Art

A conventional decoration mounted around an article has a body, a center and a through hole. The through hole is defined through the center of the body. One end of the article extends through the through hole to hang the decoration on the article.

A conventional bicycle wheel for children has multiple spokes and each spoke is mounted with many above decorations such as colorful beads to attract children. When hanging decorations on the spoke, a manufacturer detaches one end of spoke from the wheel and extends the detached end through a through hole of the decoration. Then the manufacturer assembles the detached end of the spoke on the wheel again. However, it is not convenient for the manufacturer to mount the decorations.

Furthermore, conventional hairpin for girls has decorations mounted on the hairpin. However, a user cannot change the decorations since the decorations are mounted securely on the hairpin.

### SUMMARY OF THE INVENTION

The objective of the present invention is to provide a fastener assembly can be mount around an article for ornament. Therefore, the fastener assembly is mounted around the article without via ends of the article.

To achieve the foregoing objective, a fastener assembly in accordance with the present invention has a through hole, a first element and a second element. The through hole is defined through the fastener assembly. Each of the first element and the second element has a lower part and an upper part. The upper part is mounted on the lower part. The lower part of the second element is mounted detachably on the upper part of the first element. The upper part of the second element is mounted detachably and pivotally to the lower part of the first element. The fastener assembly is mounted around an article via pivoting the first element relative to the second element without extending one end of the article through the through hole.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a fastener assembly in accordance with the present invention;

FIG. 2 is another exploded perspective view of the fastener assembly in FIG. 1;

FIG. 3 is a perspective view of the fastener assembly in FIG. 1 showing a pivot pin of a first element is mounted pivotally in a pin hole of a second element;

FIG. 4 is a top view of the fastener assembly in FIG. 3 showing that a notch of the first element engages with a protruding boss of the second element;

FIG. 5 is a top view of the fastener assembly in FIG. 3;

FIG. 6 is a cross sectional side view of the fastener assembly in FIG. 4;

FIG. 7 is an operational side view of the fastener assembly in FIG. 4 mounted around a wheel hub of a bicycle;

FIG. 8 is an operational side view in partial section of the fastener assembly in FIG. 4 mounted around an article; and

FIG. 9 is an operational side view in partial section of the fastener assembly mounted around hair.

### DETAILED DESCRIPTION OF THE PREFERRED EMBODIMENTS

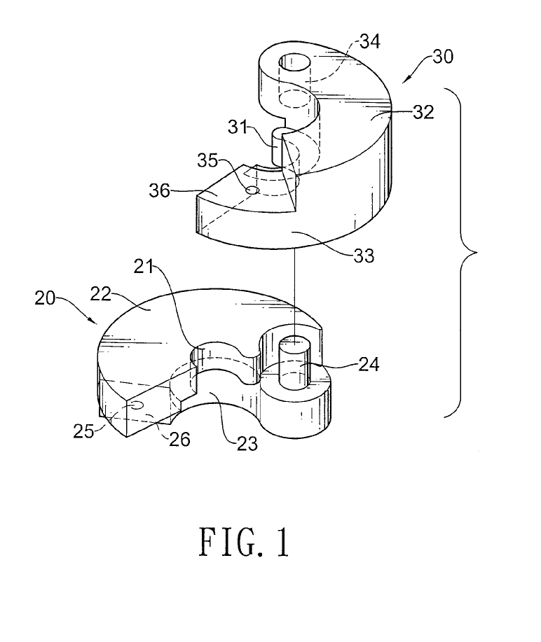

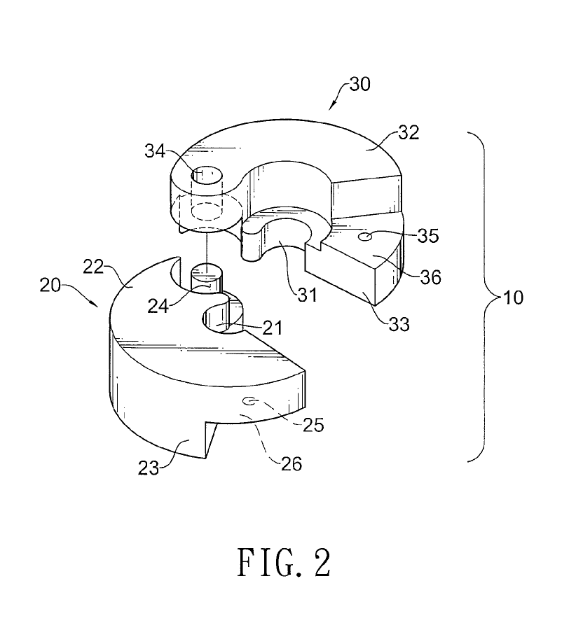

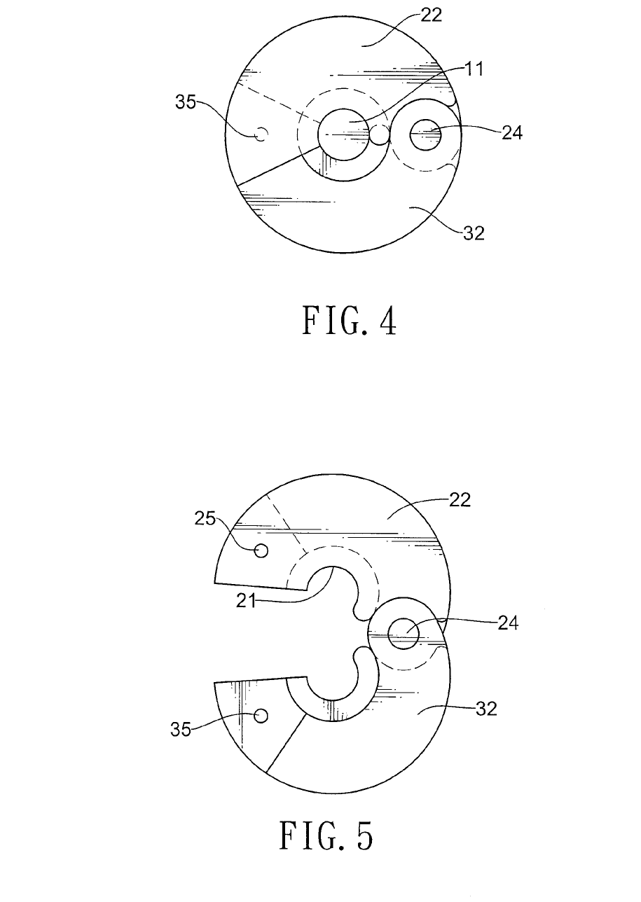

With reference to FIGS. 1, 2 and 4, a fastener assembly (10) in accordance with the present invention comprises a through hole (11), a first element (20) and a second element (30) and may be cylindrical, cubic-shaped, hexagon-shaped, animal-shaped or cartoon-shaped.

The through hole (11) is defined through the fastener assembly (10), is circular and comprises a dimension, a center and two openings. The dimension on the center is less than the dimension on the openings.

The first element (20) comprises a lower part (23), an upper part (22), a pivot pin (24), a fastener (26) and a first through hole half (21). The lower part (23) comprises a top. The upper part (22) is mounted on the lower part (23) and comprises a bottom and an inner surface. The pivot pin (24) is formed and protrudes out of the top of the lower part (23). The fastener (26) is formed on the bottom of the upper part (22) and may have a notch (25) formed on the fastener (26). The first through hole half (21) is defined in the inner surface of the upper part (22).

The second element (30) corresponds with the first element (20) and comprises a lower part (33), an upper part (32), a pin hole (34), a fastener (36) and a second through hole half (31). The lower part (33) comprises a top and an inner surface and engages with the upper part (22) of the first element (20). The upper part (32) is mounted on the lower part (33), is detachably and pivotally mounted the lower part (23) of the first element (20) and comprises a bottom. The pin hole (34) is defined in the bottom of the upper part (32) and are mounted rotatably around the pivot pin (24). The fastener (36) is formed on the top of the lower part (33) and selectively engages with the fastener (25) of the first element (20) and may have a protruding boss (35). The protruding boss (35) is formed on the fastener (25) of the first element (25), corresponds to and detachably engages with the notch (25) of the first element (20). The second through hole half (31) is defined in the inner surface of the lower part (33) and cooperates with the first through hole half to form the through hole (11). A cross section of the through hole (11) is stepped to increase the force of attachment.

The pivot pin (24) on the top of the lower part (23) of the first element (20) may be replaced with a pivot pin. The pin hole (34) in the bottom of the upper part (32) of the second element (30) may be replaced with a pivot pin to correspond to the pin hole in the first element (20).

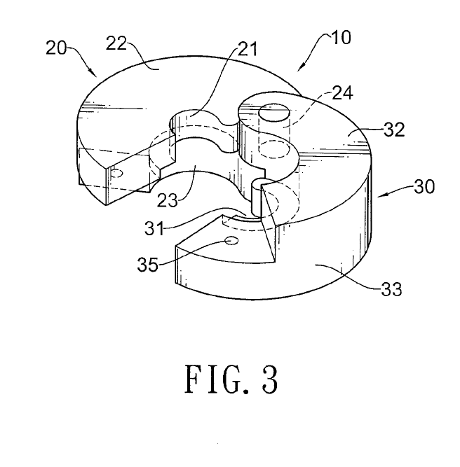

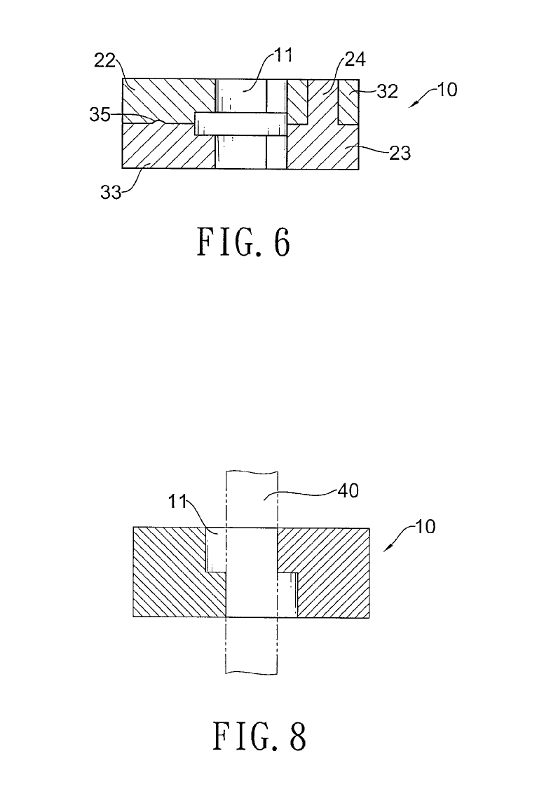

With reference to FIGS. 3, 5, 6 and 8, the pivot pin (24) is mounted rotatably in the pin hole (34). When the first through hole half (21) and the second through hole half (31) are mounted around an article (40), a user pivots the first element (20) to engage with the second element (30) so that the protruding boss (35) of the second element (30) engages with the notch (25) of the first element (20). Therefore, the first through hole half (21) and the second through hole half (31) combines to form the through hold (11) to be mounted around the article (40).

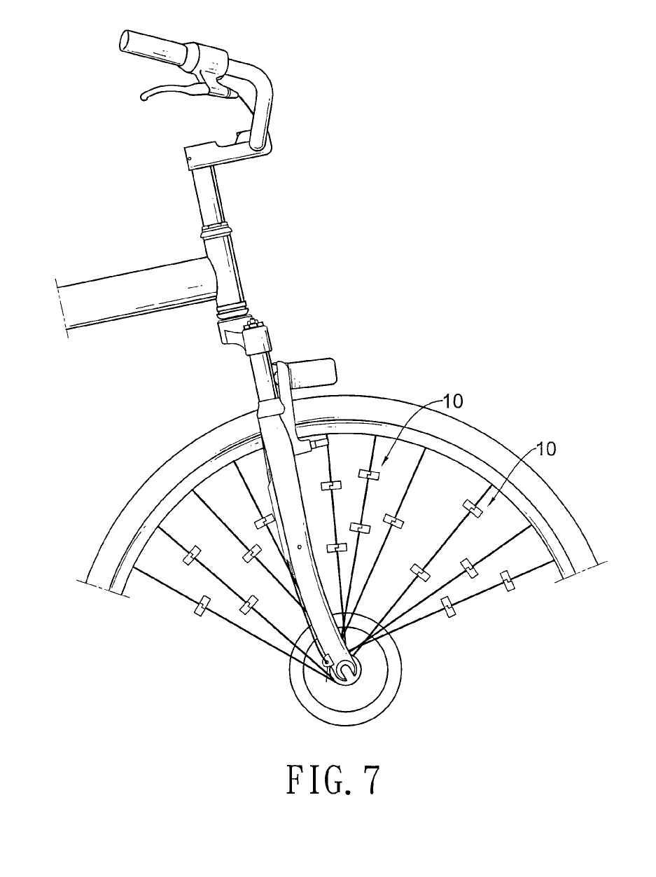

With reference to FIGS. 7 and 8, the fastener assembly (10) is mounted around a wheel spoke of a bicycle. Because the first through hole half (21) is formed on the upper part (22) of the first element (20) and the second through hole half (31) is formed on the lower part (33) of the second element (30), the through hole (11) is stepped to increase the force of attachment. The fastener assembly (10) is mounted around the wheel spoke without detaching one end of the wheel spoke.

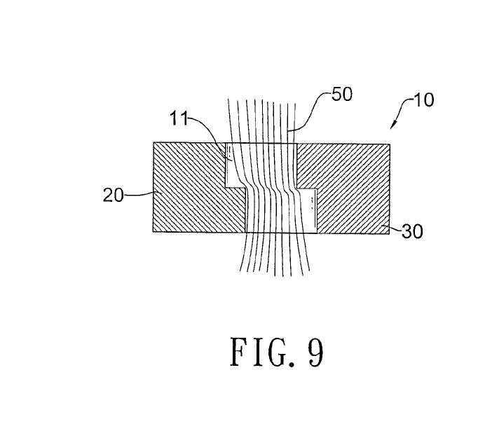

With reference to FIG. 9, when the through hole (11) is mounted around the hair (50), the fastener assembly (10) does not drop from the hair (50) since the dimension on the center of the through hole (11) is less than the dimension on the openings.

The fastener assembly (10) comprises the first element (20) and the second element (30). The first element (20) is mounted detachably and pivotally to the second element (30) to attach the article. Therefore, the fastener assembly (10) is mounted around the article via pivoting the first element (20) relative to the second element (30) to engage with the second element (30) without extending one end of the article through the through hole (11).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A fastener assembly comprising
a through hole defined through the fastener assembly;
a first element having
a lower part having a top;
an upper part mounted on the lower part and having
a bottom; and
an inner surface;
a pivot pin formed on and protruding out of the top of the lower part;
a fastener formed on the bottom of the upper part; and
a first through hole half defined on the inner surface of the upper part; and
a second element pivotally connected with the first element and having
a lower part having
a top; and
an inner surface;
an upper part mounted on the lower part and having a bottom;
a pin hole defined in the bottom of the upper part and in which the pivot pin is mounted rotatably;
a fastener formed on the top of the lower part and selectively engaging with the fastener of the first element; and
a second through hole half defined on the inner surface of the lower part and cooperating with the first through hole half to form the through hole.

2. The fastener assembly as claimed in claim 1, wherein
the fastener of the first element has a notch formed on the fastener; and
the fastener of the second element has a protruding boss formed on the fastener and detachably engaging with the notch of the first element.

3. The fastener assembly as claimed in claim 1, wherein a cross section of the through hole is stepped.

4. The fastener assembly as claimed in claim 2, wherein a cross section of the through hole is stepped.

5. The fastener assembly as claimed in claim 4, wherein the through hole is circular.

6. The fastener assembly as claimed in claim 3, wherein the fastener assembly is cylindrical.

7. The fastener assembly as claimed in claim 5, wherein the fastener assembly is cylindrical.

8. A fastener assembly comprising
a center;
a through hole defined through the fastener assembly;
a first element having
a lower part having an inner surface;
an upper part mounted on the lower part; and
a first through hole half defined on the inner surface of the upper part; and
a second element pivotally connected with the first element and having
a lower part detachably engaging with the upper part of the first element and having an inner surface;
an upper part mounted on the lower part and detachably and pivotally mounted on the lower part of the first element; and
a second through hole half defined on the inner surface of the lower part and cooperating with the first through half to form the through hole.

9. The fastener assembly as claimed in claim 8, wherein
the first element has
a pivot pin formed on and protruding out of a top of the lower part; and
a fastener formed on the fastener assembly of the upper part; and
the second element has
a pin hole defined in a bottom of the upper part and in which the pivot pin is mounted rotatably; and
a fastener formed on a top of the lower part and selectively engaging with the fastener of the first element.

10. The fastener assembly as claimed in claim 9, wherein
the fastener of the first element has a notch; and
the fastener of the second element has a protruding boss corresponding to and detachably engaging with the notch of the first element.

11. The fastener assembly as claimed in claim 8, wherein a cross section of the through hole is stepped.

12. The fastener assembly as claimed in claim 9, wherein a cross section of the through hole is stepped.

13. The fastener assembly as claimed in claim 10, wherein a cross section of the through hole is stepped.

14. The fastener assembly as claimed in claim 11, wherein the assembly is cylindrical.

15. The fastener assembly as claimed in claim 12, wherein the assembly is cylindrical.

17. The fastener assembly as claimed in claim 13, wherein the assembly is cylindrical.
